(19) United States
(12) Patent Application Publication
(10) Pub. No.: US 2014/0347659 A1
(43) Pub. Date: Nov. 27, 2014

(54) Stationary Waveguide Spectrum Analyser

(71) Applicants: Dominic Murphy, Tullamore (IE); Kieran O'Manhoney, Waterford (IE)

(72) Inventors: Dominic Murphy, Tullamore (IE); Kieran O'Manhoney, Waterford (IE)

(73) Assignee: Waterford Institute of Technology, Waterford (IE)

(21) Appl. No.: 14/115,575

(22) PCT Filed: Apr. 27, 2012
(86) PCT No.: PCT/EP2012/057826

§ 371 Date: Apr. 10, 2014

(30) Foreign Application Priority Data
May 3, 2011 (GB) 1107227.9

(51) Int. Cl. G01J 3/02; G01J 3/28

(52) U.S. Cl. CPC G01J 3/0218; G01J 3/2803; G01J 3/2823
USPC 356/300

(57) ABSTRACT

A waveguide spectrum analyser comprises an input waveguide (10) for receiving a beam of electromagnetic radiation to be spectrally analysed, a plurality of output waveguides (14, 16) which are single mode for wavelengths longer than a certain minimum, a substantially wavelength independent splitter (18) for splitting the input radiation between the single-mode output waveguides, and an array (24) of radiation-sensitive detector elements (30). Each output waveguide has a respective exit port (20, 22) facing the detector array so that radiation from the exit port is diffracted onto the array. The separation of the exit ports and the distance to the detector array is selected such that at least for a range of wavelengths longer than the certain minimum a plurality of interference fringes are produced at the array each extending across sufficient detector elements to allow spatial sampling of the fringes above the Nyquist rate. Data processing means (26) is provided for sampling the detector array to capture an image of the fringes and transforming the captured image data to the frequency domain, preferably using HTP and/or DFTS processing techniques.

This invention relates to a stationary waveguide broadband spectrum analyser, i.e. an analyser that in operation requires no relatively moving parts (although this does not rule out parts that can be adjusted prior to operation).

The invention is applicable especially, but not necessarily, to an optical waveguide spectrum analyser for the spectral analysis of light. In the present specification, light includes any wavelength which can be transmitted by internal reflection in a transparent medium, and therefore includes UV and IR wavelengths as well as visible wavelengths.

Spectrometers are widely used in a variety of disciplines for measurement of a diverse quantity of measurands. Interferometry-based spectrometer systems consist of either temporally scanned configurations or spatially scanned configurations that are typically stationary.
Stationary systems are typically constructed using bulk optic components which are inherently bulky, unwieldy and susceptible to vibration.
Temporally scanned systems require delay calibration due to non-uniform delay scanning speeds. They are also limited in their scanning bandwidths.

Many commercially available spectrometers are based on diffraction grating technology. These devices are not inherently capable of characterization of wide spectral bandwidths without scanning, which again introduces moving parts to the system.

A fibre device is known which act as a Young's slits device and is used to produce a diffraction pattern at the detector (see “Electronically scanned optical-fiber Young's white-light interferometer”, S. Chen et al., Optics Letters, Vol. 16, No. 10, 15 May 1991, Page 761). This device uses the interference fringe visibility profile to detect optical path length changes and is therefore not inherently capable of the spectral analysis of sources.

A second fibre device has been reported which acts as a wavemeter (see ‘James J. Snyder and Stephen L. Kwiatkowski, “Wavelength measurement with a Young's interferometer, Opt. Eng. 44, 083602 (Aug. 23, 2005); doi:10.1117/1.2030947”’). This device is based on an unbalanced interferometric configuration. It is, therefore, incapable of characterizing low coherence sources as it does not scan through a zero delay point and cannot produce an interferogram when a broadband source is used to illuminate the interferometer. This wavemeter embodiment also uses fringe counting to determine wavelength and is therefore not capable of interrogating more than a single wavelength in any one scan.

U.S. Pat. No. 6,016,197 (Krivoshlykov) describes a spectral analyser which uses a lens for performing a Fourier transformation. The use of a bulk optical component is undesirable.

Marcenac, D. D. et al: “Maximum-entropy optical spectrum analyser”, Optics Letters, 20, 1995, pp. 1074-1076 concerns the examination of laser lines and monochromatic light in a narrow spectral range. It is therefore not directed to a broadband solution.

To date, as far as we are aware, stationary interferometric Fourier transform devices for broadband applications are bulk optic and generally use a form of a Michelson interferometer.

According to the present invention there is provided a waveguide spectrum analyser comprising:
an input waveguide for receiving a beam of electromagnetic radiation to be spectrally analysed,
a plurality of output waveguides which are single mode for wavelengths longer than a certain minimum,
a substantially wavelength independent splitter for splitting the input radiation between the single-mode output waveguides,
an array of radiation-sensitive detector elements, each output waveguide having a respective exit port facing the detector array so that radiation from the exit port is diffracted onto the array, the separation of the exit ports and the distance to the detector array being selected such that at least for a range of wavelengths longer than the certain minimum a plurality of interference fringes are produced at the array each extending across sufficient detector elements to allow spatial sampling of the fringes above the Nyquist rate, and
data processing means for sampling the detector array to capture an image of the fringes and transforming the captured image data to the frequency domain.

Preferably the data processing means transforms the captured image data to the frequency domain using at least one of HTP and DFTS processing.

The invention permits the analysis of broadband sources at least over the range 200 nm to 2500 nm, depending on the materials selected.

In a preferred embodiment the electromagnetic radiation is light and the input and output waveguides are optical waveguides, most preferably optical fibre waveguides but alternatively optical waveguide chips.

The input waveguide may be a single-mode waveguide. Alternatively it may be a multi-mode waveguide and the input radiation is distributed by the splitter between more than two single-mode waveguides.

The spectrum analyser further includes means to provide a reference image data to the processing means, the reference image being formed on the detector array by radiation of known wavelength.

The invention also provides a method for the spectral analysis of a beam of electromagnetic radiation, the method comprising:
coupling the beam into an input waveguide,
using a substantially wavelength independent splitter to split the beam between a plurality of output waveguides which are single mode for at least a range of wavelengths of the electromagnetic beam,
each output waveguide having a respective exit port facing an array of radiation-sensitive detector elements so that radiation from the exit port is diffracted onto the array, the separation of the exit ports and the distance to the detector array being selected such that at least for the said range of wavelengths a plurality of interference fringes are produced at the array each extending across sufficient detector elements to allow spatial sampling of the fringes above the Nyquist rate, and
sampling the detector array to capture an image of the fringes and transforming the captured image data to the frequency domain.

Although the embodiments of the invention described herein are designed for the spectral analysis of light, the invention is applicable to the spectral analysis of electromagnetic radiation in general, it being understood that the nature of the waveguides and detector array will be selected according to the wavelengths concerned.

Embodiments of the invention will now be described, by way of example, with reference to the accompanying drawings, in which:

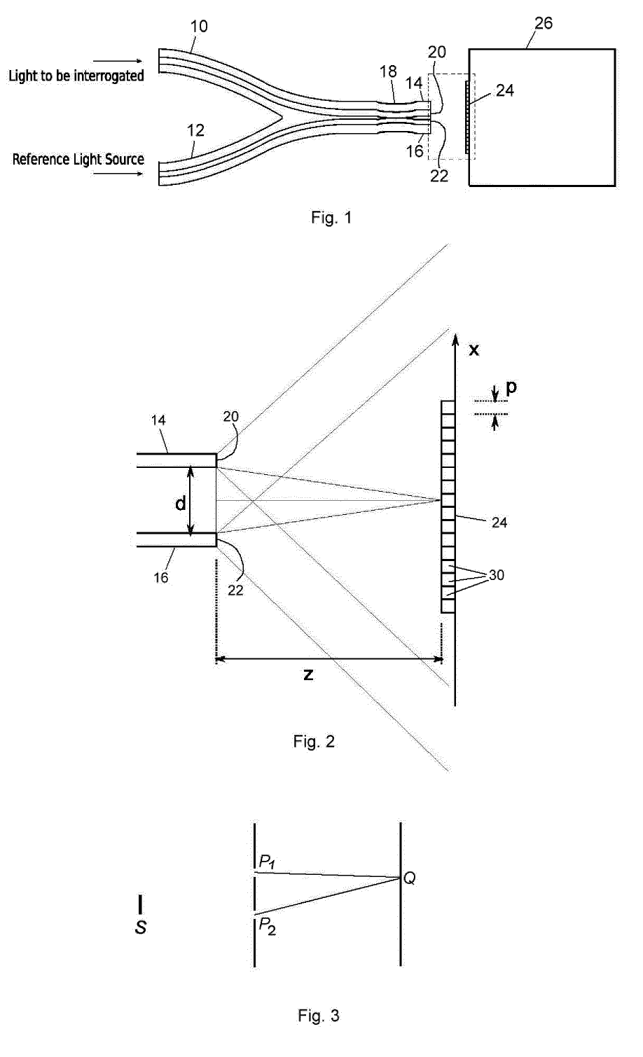

FIG. 1 is a schematic diagram of an embodiment of the invention.

FIG. 2 is an enlarged view of the region within the dashed rectangle in FIG. 1.

FIG. 3 is a simplified version of FIG. 2.

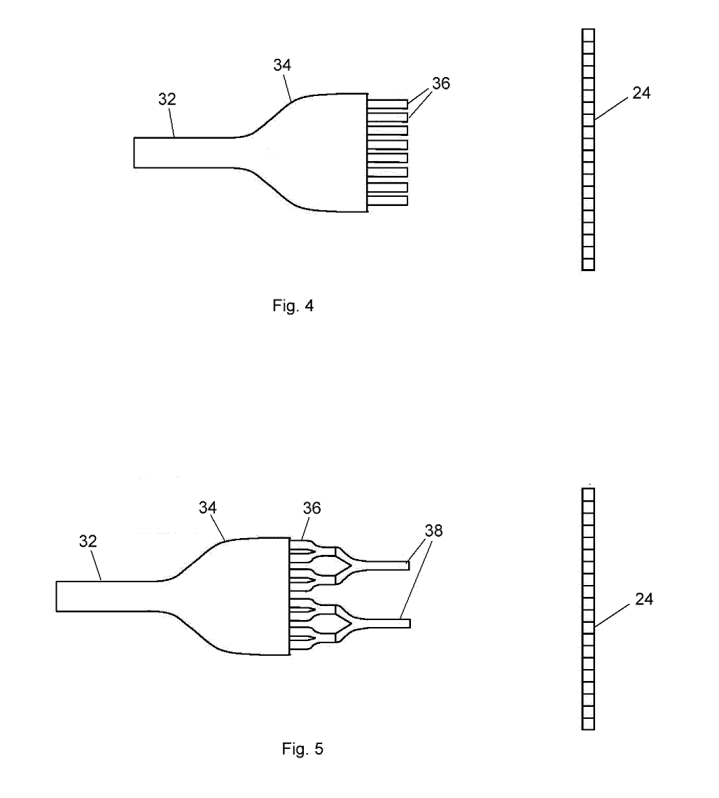

FIG. 4 is a schematic diagram of an embodiment of the invention that accepts multi-mode input light and distributes it between multiple single-mode outputs.

FIG. 5 is a schematic diagram of an embodiment of the invention that accepts multi-mode input light, distributes it between multiple single-mode outputs and combines the multiple single-mode outputs into 2 single-mode outputs.

FIG. 1 is a schematic diagram of a spectrum analyser based upon a fibre-optic interferometer. The interferometer includes first and second input arms 10, 12 and first and second output arms 14, 16, each arm 10-16 comprising a respective fibre-optic waveguide. A 2×2 splitter 18 splits the light from each input arm 10, 12 between the output arms 14, 16. The splitter 18 is substantially wavelength-independent and splits the input light substantially equally between the output arms. As will be described, in certain embodiments the input arm 12 can be omitted, in which case the splitter 18 may be replaced by either a 1×2 splitter or a wavelength independent y-junction. Each fibre-optic waveguide comprising the arms 10-16 is single mode for wavelengths longer than a certain minimum wavelength corresponding to the highest frequency of light for which the spectrum analyser is designed to work.

In use, a beam of light to be interrogated (i.e. spectrally analysed) is coupled into the input arm 10 and split, independently of wavelength, equally between the two output arms 14, 16 by the splitter 18. The input arm 12, when present, is used to receive a monochromatic reference beam, as will be described. This too is split equally between the two output arms 14, 16 by the splitter 18 and is used to calibrate the spectrum analyser. Each output arm 14, 16 has a respective exit port 20, 22 facing a CCD array 24 of individual photosensitive detector elements (pixels) 30, FIG. 2, so that light from the exit ports is diffracted onto the array to form interference fringes produced by overlapping divergent wavefronts from the exit ports. At the site of each pixel, the fields due to the overlapping beams provide an intensity which depends on the relative delay difference. This delay difference evolves across the detector array to form the interference fringes.

The interference fringe frequency is wavelength dependent. Thus the total interferogram generated across the detector array can be Fourier processed to provide a spectral characterization of the light illuminating the interferometer.

This is done by dedicated processing electronics (or a suitably programmed PC) 26 which captures an image of the fringes from the array by sampling the array at above the Nyquist rate, and transforms the captured image data to the frequency domain by Fourier analysis.

Preferably, but not necessarily, the two single-mode optical fibre arms 14, 16 are substantially identical in material, waveguide dimension, index contrast and length so that the light propagating along each arm experiences the same optical path delay and dispersion in each arm. In the embodiment shown in FIG. 1 the arms 14, 16 are fused together and cleaved as close as possible to the splitter 18. The short length fused arms 14, 16 assist in providing a common mode temperature sensitivity to reduce or eliminate the introduction of relative path length differences between the interferometer arms. This also helps to ensure that the zero delay point is scanned at the detector array. In other embodiments the output arms 14, 16 may be wound around each other and cleaved as close as possible to the splitter 18 to obtain similar common mode temperature dependence.

As the light exits the port 20 or 22 it will diffract into the surrounding medium with a divergence angle governed by the wavelength dependent numerical aperture (NA) of the fibre.

NA=\sqrt{n_{co}²−n_{cl}²} (1)

where n_{co} is the wavelength dependent refractive index of the single-mode optical waveguide core and n_{cl} is the wavelength dependent refractive index of the single-mode optical waveguide cladding.

FIG. 2 illustrates the exit ports 20, 22 of the two output arms 14, 16 and the divergence of the exit beams into the surrounding medium, e.g. air (only the cores of the arms 14, 16 are shown in FIG. 2, the cladding being omitted to simplify the diagram). Having exited the respective optical fibre arm output ports 20 and 22, the respective light beams will overlap to form a spatial interference pattern (spatial interferogram), across their overlapping wavefronts. The separation of the exit ports 20, 22 and the distance to the detector array 26 is selected such that, at least for a range of wavelengths longer than the minimum wavelength for which the arms 10-16 are single mode, a plurality of interference fringes are produced at the array each extending across sufficient detector elements to allow spatial sampling of the fringes above the Nyquist rate to prevent aliasing.

In the present embodiment the array 24 is linear and the exit ports 20, 22 are spaced apart in the longitudinal direction of the array. At the ports 20, 22 the optical axes of the arms 14, 16 are mutually parallel and normal to the array 24. However, in other embodiments the relative delay between the beams from the two exit ports can be varied by changing the angles at which the light is launched from the exit ports 20, 22 (which need not be parallel) and/or by changing the separation of the two exit ports. The relative delay should be such that the zero delay position is scanned to enable spectral analysis of low-coherence sources.

The divergent output beams from the two exit ports 20, 22 may be collimated so that the beams do not diverge beyond the limits of the array 24.

Referring to FIG. 3, a simplified version of FIG. 2, a measure of the correlation that exists between the vibrations at two arbitrary points in a wave field that is due to light emitted from a polychromatic extended source S is achieved through the analysis of the operation of the two-beam interferometer that is shown in FIG. 3. A complex disturbance A (Q, t) at Q is given by

A(Q, t)=K₁A(P₁,t−t₁)+K₂A(P₂,t−t₂) (2)

where P₁ and P₂ are the centres of secondary disturbances and t₁ and t₂ are the times taken for the light to travel from P₁ to Q and from P₂ to Q respectively. The intensity I(Q) at Q is then given by the general interference law for partially coherent light as

I(Q)=I₁(Q)+I₂(Q)+2\sqrt{I₁(Q)}\sqrt{I₂(Q)} [symbol] [\tilde{γ}₁₂(τ) (3)

where I₁(Q) and I₂(Q) are the irradiances from the respective optical fibre arms, [symbol] denotes the real part of a complex number, \tilde{γ}₁₂(τ) is the complex mutual degree of coherence function and τ represents delay.

In the case where I₁≅I₂ and illumination is by a narrow line-width source of mean optical frequency ω̅, and there is a non-dispersive imbalance between the arms of the interferometer, the equation becomes

I(τ)=2I₀[1+V(τ)cos φ(τ)] (4).

where I₀=I₁=I₂. Here, V(τ) is a slowly varying irradiance envelope function that is the interferogram visibility, and the temporal evolution of phase is given by φ(τ)= ω̅τ.

Considering FIG. 3, where the interferometer is illuminated with a spatially coherent beam from a narrow line-width source of mean optical angular frequency ω̅, the intensity distribution along the x-direction on the detector array plane is given by

I(x)=2I₀[1+V(x)cos φ(x)] (5).

In this equation, the visibility V(x) varies slowly with x due to the quasi-monochromatic nature of the source, and the spatial evolution of phase φ(x) is given by

φ(x)={k(x)φ(τ)+φ_{C}} (6).

In a manner analogous to the stationary Michelson interferometer, the term k(x) is constant in the case of negligible separation d between the fibre output arms and in the case of perfectly plane surfaces on the fibre ends. In practice, however, ideal surfaces cannot be guaranteed and a non-negligible separation d is deliberately applied in order to achieve a scan of the optical path delay; the x dependence of k(x) is therefore explicitly included. A phase correction term φ_{C} is introduced to allow an arbitrary choice of delay origin. An expression for the intensity distribution across the pixel array I(x) in terms of phase evolution φ(τ) is then

I(x)=2I₀[1+V(x)cos{k(x)φ(τ)+φ_{C}}] (7).

When a reference laser beam, of optical frequency ω̅_{R}, simultaneously and collinearly propagates through the fibre arms of the interferometer, the reference interferogram is also formed across the detector array. By analogy with Eq. 7, the intensity distribution in the x direction, see FIG. 2, can be written as

I_{R}(x)=2I_{0R}[1+V_{R}(x)cos{k_{R}(x)φ_{R}(τ)+φ_{CR}}] (8)

where subscript ‘R’, is used to denote terms relating to the reference laser.

As the numerical aperture (NA) of the optical fibre is wavelength dependent, the phase evolution φ(x) of the interference pattern for each source wavelength will be unique and will give rise to a distinct interference pattern.

For a fixed source frequency or wavelength, fixed NA fibres and coplanar fibre ports, the evolution of interferogram phase φ(τ) across the detector array plane is governed by the separation between the ends of the fibre ports, d and the distance, z between the fibre ends and the detector array plane, as shown in FIG. 2.

For a cylindrical optical fibre, the condition for single-mode operation is

$$V = \frac{2 π}{λ} a \sqrt{{n}_{co}^{2} - {n}_{cl}^{2}} < 2.405 \qquad ( 9 )$$

where V is the waveguide parameter, λ is the vacuum wavelength of light, a is the core radius, n_{co} is the core refractive index and n_{cl} is cladding refractive index.

Silica has a transmission window that spans the wavelength range from ˜200 nm to ˜2000 nm. As such, silica is the preferred material for optical fibres in this wavelength region. For extended wavelengths, there are a range of soft glass materials such as germanate and chalcoginide that provide transmission windows out into the mid IR.

In one embodiment a visible/near IR stationary optical fibre waveguide spectrum analyser based on FIG. 1 uses fibre which is single-mode from 400 nm upwards to match the spectral bandwidth (400-1000) nm of the silicon detector array 26.

In another embodiment a telecoms wavelength version of the stationary optical fibre waveguide spectrum analyser uses smf-28 optical fibre that operates single-mode for wavelengths above 1260 nm and an InGaAs detector array with spectral bandwidth (900-1700) nm.

It is possible to get enhanced InGaAs detector arrays that can operate up to 2200 nm and 2500 nm.

There are a number of methods of referencing the interferometer. When the input arm 12 is present the device allows a reference beam of known wavelength to be launched to co-illuminate the detector array 24 with the light to be interrogated, as described above. In such a case the wavelength of the reference beam should be separable from the wavelength range of the light to be interrogated in the frequency domain. Alternatively, the device can be precalibrated by introducing the reference beam into the arm 10 or, if present, the arm 12, with reference images produced thereby stored in a database for subsequent use by the data processing electronics 26.

As shown in FIG. 2, at a point on the detector array the light from both arms will have travelled the same distance, the zero delay point. The delay between the beams produces the interference fringes across the detector array. The total number of fringes depends on the optical path delay across the detector array as follows:

The path difference, ΔPD, between the beams exiting from port 1 and port 2 is determined by the separation of the two ports, d, the distance to the detector array, z, and the spatial extent of the detector array, x.

$$Δ PD ≅ \frac{xd}{z} \qquad ( 10 )$$

In the observation plane the fringe intensity varies sinusoidally with x as

$$I ( x ) = 1 + cos ( \frac{2 π }{λ} \frac{xd}{z} ) \qquad ( 11 )$$

where λ is the wavelength of the light.

As mentioned above, the sinusoidal variation I(x) is sampled above the Nyquist rate at the highest frequency of light to be interrogated to prevent aliasing.

The material of the detector array 26 depends on the wavelengths (or frequencies) of the light to be interrogated. For example, a silicon CCD or CMOS detector array can be used to interrogate light at visible and NIR wavelengths. An InGaAs detector array can be used to interrogate light from ˜1000 nm through to ˜2000 nm. (The determination of the detector array type depends on the responsivity to the wavelength of the light to be interrogated and the optical power. It has been shown for example, that where high optical powers are used InGaAs detector arrays can also be used for detection of visible wavelengths.)

In one example, the fibre has a numerical aperture of 0.13@1550 nm, the fibres exit port ends are separated by ˜5 mm, the distance to the detector array is ˜200 mm, the detector array has 512 pixels with a pitch p (FIG. 2) of 25 μm and the no. of pixels per fringe we achieve is ˜4. This can be adjusted by adjusting the position of the detector array 26. The resolution @1550 nm achieved with this ˜4 pixels per fringe and the 512 pixel array is ˜12 nm FWHM from a delay scan length of ˜200 μm. If this sample density is reduced to, for example ˜3 pixels per fringe, the delay scan length increases to ˜265 μm, increasing the FWHM resolution to ˜9 nm for 1550 nm light.

The foregoing assumes that the input arm 10 is a single mode fibre. Multi-mode light that is incident on single-mode fibre is spatially filtered so that only a single mode of the incident light is propagated in the single-mode fibre. This leads to a loss of optical input power to ensure high optical resolution of the signal.

Recently, the photonic lantern has been used to capture multi-mode light in a multi-mode fibre and then distribute it with minimum loss into a plurality of single-mode fibres (see “Multimode fiber devices with single mode performance”, S. G. Leon-Saval et al., Optics Letters, Vol. 30, No. 19, 1 Oct. 2005, Page 2545). Using this approach, it is possible to extend the stationary waveguide interferometer to interrogate multi-mode light. Possible options to resolve the spectral content of this multi-mode light are shown in FIGS. 4 and 5.

In FIG. 4, multi-mode light captured with a multi-mode waveguide 32 is split by a transformer 34 between multiple single-mode waveguides 36 whose outputs are diffracted onto the detector array 24 to form a multiple beam interference pattern.

In FIG. 5, multi-mode light captured with the multi-mode waveguide 32 is split between multiple single-mode waveguides 36 as above. However, the number of single-mode waveguides 36 is reduced to two through combining the multiple single-mode outputs by stages into two single-mode waveguides 38 whose outputs are diffracted onto the detector array 24 to form a 2-beam interference pattern. This will achieve the same performance as the 2 arm interferometer configuration described in FIG. 1.

The interferograms are captured and Fourier transform processed to retrieve information, such as the spectral content, of the light illuminating the detector array.

DFTS

Having detected an interferogram or interferogram ensemble at the detector array 26, it is captured using a frame grabber and stored for processing on the processing electronics or computer 26. Dispersive Fourier Transform Spectrometry (DFTS) can be used to recover optical frequency and phase information. From Equation (3), the oscillatory part of the interferogram, Iₒₛ is

Iₒₛ=2\sqrt{I₁(Q)}\sqrt{I₂(Q)} [symbol] [\tilde{γ}₁₂(τ)] (12)

As a consequence of the optical equivalent of the Wiener-Khintchine theorem, the complex degree of coherence function \tilde{γ}₁₂(τ) and the normalised complex interferogram spectrum \tilde{G}(ω)exp[−i φ₁₂(ω)] are Fourier transform pairs. This may be expressed mathematically as

\tilde{γ}₁₂(τ)=∫_{-∞}^{∞}{\tilde{G}(ω)exp[−i φ₁₂(ω)]}exp[−i ωτ]dω (13)

Defining the complex spectrum \tilde{S}(ω) of the interferogram as

\tilde{S}(ω)=\tilde{G}(ω)exp[−i φ₁₂(ω)] (14)

it follows that

\tilde{γ}₁₂(τ)= [symbol] ⁻¹{\tilde{S}(ω)} (15)

Then, using the linearity of the Fourier transform [symbol] { }

$$\begin{matrix}2 [ {\tilde{γ}}_{12} ( τ ) ] = {\tilde{γ}}_{12} ( τ ) + {\tilde{γ}}_{12}^{*} ( τ ) \\ = {- 1}^{} \{ \tilde{S} ( ω ) \} + {- 1}^{} \{ {\tilde{S}}^{*} ( ω ) \} \\ = {- 1}^{} \{ \tilde{S} ( ω ) + \tilde{S} ( - ω ) \}\end{matrix} \qquad ( 16 )$$

where [symbol] ⁻¹{ } denotes the inverse Fourier transform, * denotes the complex conjugate and \tilde{S}(ω) is Hermitian. For negative optical frequencies \tilde{G}(ω) and therefore \tilde{S}(ω) are zero-valued so that from Equation (16)

\tilde{S}(ω)= [symbol] {2 [symbol] [\tilde{γ}₁₂(τ)]}, for all ω>0 (17)

Combining Equation (12) with Equation (17):

\tilde{G}(ω)exp[−i φ₁₂(ω)]∝ [symbol] {Iₒₛ(τ)};

and \tilde{G}(ω)∝| [symbol] {Iₒₛ(τ)}| (18)

The spectral phase is then found from the argument of the Fourier transform of the interferogram

φ₁₂(ω)=arg [symbol] {Iₒₛ(τ)} (19).

Equation (19) forms the basis of DFTS processing.

HTP

The Hilbert transform processing (HTP) approach is used for measurements of mean wavelengths or frequencies. The technique is based on the comparison between recovered phase values from the respective analytic signals of the signal and reference sources that illuminate the interferometer. In the case of an interferogram generated using quasi-monochromatic light, the spectral amplitudes will only have appreciable values in a frequency range Δω that is small compared to the mean frequency ω̅. A simple representation of the analytic signal, Aₒₛ(τ) arising from the recombination of beams with optical path difference τ is therefore

Aₒₛ(τ)=x(τ)+ih(τ) (20)

where x(τ) is the real part of the signal and ih(τ) is its associated imaginary part. The real and imaginary parts are Hilbert transforms of each other, as expressed by

x(τ)=∫₀^{∞}a(ω)cos[φ(ω)− ω̅τ]dω

ih(τ)=i∫₀^{∞}a(ω)sin[φ(ω)− ω̅τ]dω (21).

Recovery of the analytic signal from a captured interferogram is therefore achieved as follows. A Fourier Transform \tilde{X}(ω) of the real signal x(τ) contains both positive and negative frequency components. A Fourier transform of the analytic signal is one-sided with no negative frequency components, and equal to twice the single-sided Fourier transform of the real signal

$$\begin{matrix} [ {A}_{os} ( τ ) ] = \begin{matrix}0 & ω < 0\end{matrix} \\ = \begin{matrix}2 \tilde{X} ( ω ) & ω > 0\end{matrix} .\end{matrix} \qquad ( 22 )$$

The analytic signal is found then from twice the inverse transform of the positive frequency components of the Fourier transform of the real signal

Aₒₛ(τ)=2 [symbol] ⁻¹[\tilde{X}_{POS}(ω)] (23).

Taking the argument of this complex temporal representation of the interferogram yields the desired values of temporal phase φ(τ) for the interferogram in question

$$φ ( τ ) = {tan}^{- 1} [ \frac{Im ( {A}_{os} ( τ ) )}{Re ( {A}_{os} ( τ ) )} ] . \qquad ( 24 )$$

The invention is not limited to the embodiments described herein which may be modified or varied without departing from the scope of the invention.

1. A waveguide spectrum analyser comprising:
an input optical fibre waveguide for receiving a beam of light to be spectrally analysed,
a plurality of output optical fibre waveguides which are single mode for wavelengths of light longer than a certain minimum,
a substantially wavelength independent splitter for splitting the input light between the single-mode output waveguides,
an array of light-sensitive detector elements, each output waveguide having a respective exit port facing the detector array so that light diverges from the exit port and is diffracted onto the array, the separation of the exit ports and the distance to the detector array being selected such that at least for a range of wavelengths longer than the certain minimum a plurality of interference fringes are produced at the array each extending across sufficient detector elements to allow spatial sampling of the fringes above the Nyquist rate,
means for providing reference image data relating to a reference image formed on the detector array by light of known wavelength, and
data processing means for sampling the detector array to capture an image of the fringes and transforming the captured image data to the frequency domain and for using Hilbert transform processing (HTP) to compare phase values recovered from analytic signals of the transformed data with said reference image data.

2. (canceled)

3. A waveguide spectrum analyser as claimed in claim 1, wherein there are only two output waveguides.

4. A waveguide spectrum analyser as claimed in claim 1, wherein the array is a linear array of detector elements.

5. (canceled)

6. (canceled)

7. A waveguide spectrum analyser as claimed in claim 1, wherein the input waveguide is a single-mode waveguide.

8. A waveguide spectrum analyser as claimed in claim 1, wherein the input waveguide is a multi-mode waveguide and the input light is distributed by the splitter between a plurality of single-mode waveguides.

9. A waveguide spectrum analyser as claimed in claim 8, wherein the plurality of single-mode waveguides form the output waveguides.

10. A waveguide spectrum analyser as claimed in claim 8, wherein the plurality of single-mode waveguides are combined to provide only two single-mode output waveguides.

11. (canceled)

12. A waveguide spectrum analyser as claimed in claim 1, wherein the means to provide reference image data includes a further input waveguide for receiving a reference beam simultaneously with the beam to be analysed, the splitter also splitting the reference beam between the at least two single-mode output waveguides.

13. A waveguide spectrum analyser as claimed in claim 1, wherein the reference image data is provided as pre-stored image data.

14. A method for the spectral analysis of a beam of light, the method comprising:
coupling the beam into an input optical fibre waveguide,
using a substantially wavelength independent splitter to split the beam between a plurality of output optical fibre waveguides which are single mode for at least a range of wavelengths of the light,
each output waveguide having a respective exit port facing an array of light-sensitive detector elements so that light diverges from the exit port and is diffracted onto the array, the separation of the exit ports and the distance to the detector array being selected such that at least for the said range of wavelengths a plurality of interference fringes are produced at the array each extending across sufficient detector elements to allow spatial sampling of the fringes above the Nyquist rate,
providing reference image data relating to a reference image formed on the detector array by radiation of known wavelength,
sampling the detector array to capture an image of the fringes, and
transforming the captured image data to the frequency domain and using Hilbert transform processing (HTP) to compare phase values recovered from analytic signals of the transformed data with said reference image data.

15. (canceled)
